(19) United States
(12) Patent Application Publication
(10) Pub. No.: US 2003/0187752 A1
(43) Pub. Date: Oct. 2, 2003

(54) Method for buying a service or a product by using a telephone

(76) Inventors: Pasi Kapiainen, Tampere (FI); Kalle Mustonen, Ruutana (FI)

Correspondence Address: LARSON & TAYLOR, PLC, 1199 NORTH FAIRFAX STREET, SUITE 900, ALEXANDRIA, VA, 22314, US

(21) Appl. No.: 10/381,936

(22) PCT Filed: Oct. 1, 2001
(86) PCT No.: PCT/FI01/00853

(30) Foreign Application Priority Data
Sep. 29, 2000 (FI) 20002139

(51) Int. Cl. G06F 17/60

(52) U.S. Cl. 705/26

(57) ABSTRACT

A method of buying a service or a product using a telephone apparatus, in which method the service operator has the equipment to identify the customer, who sends a message with a telephone apparatus to the service operator in order to place an order for a service. The method includes a contract between customer and service operator, whereby, when the customer calls the service operator from a contracted telephone number the service order will be accepted, when the service operator identifies the caller number to be in accordance with the contract, whereby the service operator switches on the service wanted and directs the charge of transaction to the identified customer.

The invention relates to a method of buying, leasing or obtaining a service or a product using a telephone apparatus, in which method the service or goods producer/operator has the equipment to identify the customer, who sends a message with a telephone apparatus to the service operator in order to place an order for a product or a service and the method including a contract between the customer and the service operator.

Previously known are a lot of services carried out by tele-phone, available by calling a certain number. Examples of such services are, among others, calling a taxi, switching on certain appliances by remote control and, among others, the ordinary service numbers for the public, today supplied in great diversity. Further, known by means of a call is, among others, the internet and the bank service connection and maintenance, for which the customers are charged differently. Also known are remote control devices for distant automatic doors, remote opening systems and cards in connection with transit control and other push-button lock constructions.

The above presented telephone services are direct telephone connections between the customer and the service operator and the service comes either along an opened telephone line, whereby the customer can be even a contracting customer as by internet and bank services or the receiver of the begins to carry out the service, a taxi, for instance, and there exists no service contract. Above presented functions are mutual operation between the customer and the service producer and the service producer charges the customer in one way or another.

In known automatic door systems auxiliary means are needed, for instance a transit card, an infrared sender unit etc. and also some kind of a maintenance-needing equipment close to doors, which are automatically controlled.

The above presented systems based on a customer contract are, according to contract, responsible for service arriving only along the opened, line of an ordering call. With known systems no such kind of quality is reached that anywhere and any service could be ordered by telephone, and if the caller has the telephoto with him/her and service producer, too, with whom the contract is made, there would be everywhere different services on offer that available by telephone, which are other than services coming along an opened telephone line.

By means of the method as per this invention a decisive improvement is achieved with respect to methods acquiring buying and service by present telephones and the method according to the invention is characterized in what is presented in the claims.

The advantage of the method according to the invention is that it replaces coin operated machines. In connection with previous coin operated machines the phone number the contracting customer is calling is visible and service gets switched on. Usually, each telephone apparatus has its own phone number so that the service operator can on the basis of the call switch on the right apparatus. The use of such devices is becoming lighter and more simple. Almost all coin operated machines can be modified to work according to this method. The impact of the change of coins can be forgotten. The services will be invoiced by the service operator, when until now there has been no invoice and no receipt for coin payments.

Further, any other service, such as door opening, washing, buying a product, leasing, paying the parking fee can be added to be carried out in accordance with the method of this invention. When the customer phones only the alarm signal to a certain ordering number, and the gets not switched on, the ordering itself is a free operation to the customer. Likewise, the service bidder can switch on the service ordered by customer only in the telephone of the phoned alarm signal in the device, the service of which the customer has ordered. Accordingly, identification is made on basis of the number of the caller, i.e the customer, without the actual calling line getting switched on. Since the service producer/telephone operator often is in another place than the service transmitting device, it is advantageous that also the service producer can switch on the service the customer wants by making only an alarm signal call to the service transmitting apparatus, without the call switched on, and makes thereby, however, the service to switch on.

The method as per the invention is safe, since the customer's right of use can be quickly cancelled, if necessary, in case the service operator is using, for instance, a PC based system for identification and for user reports. The net gets very little loaded by the method, since it is only fast and easy numerical techniques.

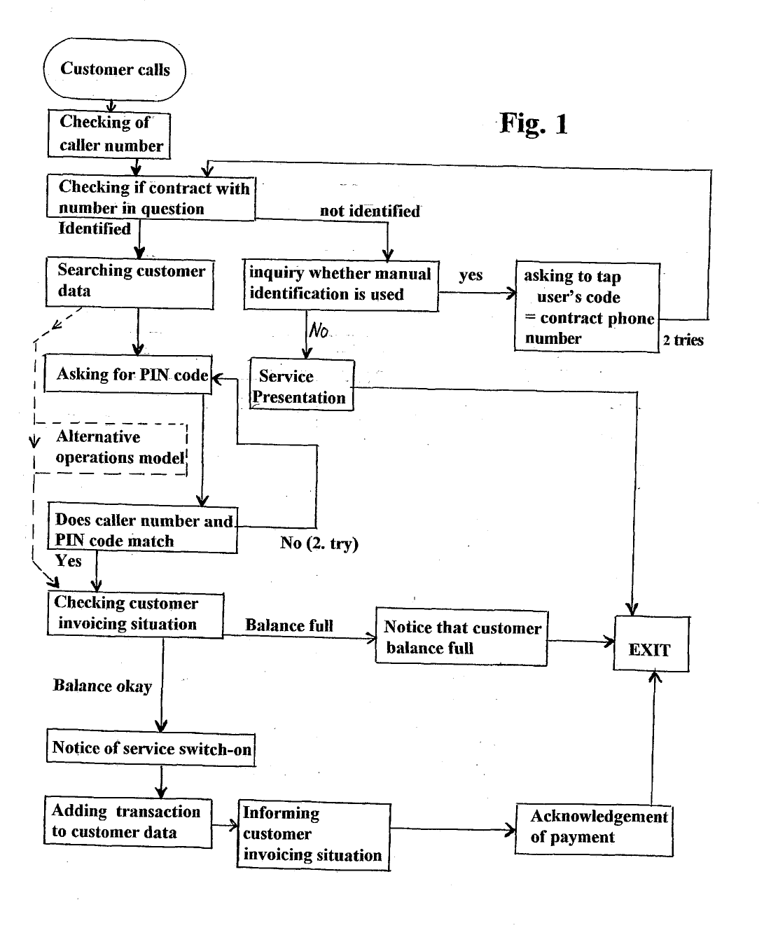

In the following the invention is disclosed with reference to the enclosed drawing, FIG. 1, where a service order is shown schematically.

The customer who has signed a contract with a service operator, calls the number of the service operator from where the wanted service can be obtained. The service operator has a lot of telephone numbers always corresponding to one service or a group of services. The number of caller is checked. If there is no contract for the number in question, the caller cannot be identified, and the call is deleted if by manual code checking or, for instance, by a PIN code inquiry the caller cannot be proved to be a contracting customer. This can come into question also if the customer calls to place an order from another person's telephone.

When the contracting customer has been identified then follows checking of the invoicing situation of the contracting customer or first can a PIN code checking be made. If the invoicing situation shows an overdraft the order attempt call can be cut off. If the contracting customer's balance of account is in order with respect to the service operator, the service operator switches on the device the customer requires. Most suitably switching-on takes place so that the service operator transmits the switching command to the phone in the device. Thus the device can be anywhere, providing that it is available by telephone. The device producing the service is located to receive a GSM cell call, for instance.

When the service is switched on, the transaction charge is added to customer's balance data. With invoicing at fixed periods, or the customer taking care that the balance with respect to the service operator remains positive, there will be benefit both for the customer and the service producer. The customer must not handle or reserve any coins nor pay for any extra if the amount of coins is not exact. The service operator must not go around collecting coins from devices, the devices are of no interest to thieves, since there are no coin boxes and there will be no problems when coins change.

Most slot machines can be replaced by the device included in the system according the invention. The service operator's own telephone cell is placed into the device and an arrangement added for switching on the device, when the telephone receives a message to start. Examples of these kinds of services and devices, which the contracting customer could switch on calling the telephone number indicated in the device are among others cloth washing in a laundry, machine wash of a car, obtaining a set of stamps from a stamp machine or buying a product from a machine. If many services or different goods are available from the machine, the function can include information of choice by a telephone push-button for instance what number indicates the product one wants to get out from the machine.

In a large-scale extent the invention can be extended to parking meters, for instance, whereby a certain parking time in the meter can be booked by telephone.

By the door-opening function the customer can call the telephone number the service operator has given him/her and which number is in the customer's files defined to be connected to the door the customer wants to open. The program in the service producer's server detects the number of the caller (customer number caller id). During the call the telephone line may not get opened if not separately the PIN code inquiry has been also defined in order to check the identification of customer. On the other hand and without saying, the PIN code can be tapped after the called number and without the call getting switched on, if the PIN code is fed as an extension after the number and the order number of door-opening is, for instance, a common switchboard number. In case the calling number has no right to door-opening, no steering information is sent to the steering gear of the door. In practice, each door needs no individual number, but the data of the customer ( the A-customer) calling a certain number of the B-customer, are compared to that which door is defined to be controlled by the respective combination of the numbers of the A-customer and B-customer. This kind of calculation shows that just as many telephone numbers would be needed in the server as there are doors in use for one (the greatest) user. Typically, such a user could be, for instance, a carrier moving in the small hours, who can in the night go even through hundreds of doors.

In one embodiment the call must not be opened not even by PIN code checking. In this case as service/product order number for the service operator a number is chosen, which is a typical switchboard number. The customer taps the switchboard number and then as extension his/hers four-figure PIN code. If the whole sequence of numbers is identified, checking of customer has taken place in the best way. Different customers have their own extensions, i.e. PIN codes.

As a steering command a mere alarm signal is enough, but for the steering gear the number can be defined, from which the steering command shall come informing that steering shall take place. In this way the illicit opening of the door by phone in an extreme case would need breaking of the next chain.

1. The secret telephone number of the automatic door opening gear must be detected.

2. One has to be able to process the secret code of A-customer, which is to be transmitted from the switchboard to the steering gear, to be such as defined for the steering gear.

3. It must be detected what data the steering gear requires in order to switch on the door control.

The contracting customer can operate and receive services or products only over the equipment of the service operator with whom the contract has been concluded. The controlling customer calls a certain number of the operator of own chose and closes the phone. In accepting the order, the service operator switches on, for instance, the device for customer's use, who has access to the telephone number, which has received the customer's call. Then the customer is in the phoning situation beside the service or the product wanted. For instance, this device can have a display asking for additional codes, such as customer's PIN code. The service operator is usually located somewhere else and receives the customer call.

In the service-producing device beside the customer there is a telephone, which the service operator calls and gives operation information. Naturally, it is possible that even the device itself could have customer identification, and then would the service be switched on, but the device itself should then be online-connected to the service operator.

1. A method of buying, leasing or obtaining a service or a product using a telephone apparatus, in which method the service or goods producer/operator has the equipment to identify the customer, who sends a message with a telephone apparatus to the service operator in order to place an order for a product or service and the method including a contract between customer and service operator and in the method the customer calls from a contracted phone number the number of the service operator in order to give a phone alarm and that the number of the calling customer is detected, but without the call getting switched on, characterized in that in the method the service order will be accepted, if the service operator identifies that the number of the customer, who has called, is in accordance with the contract, whereby the service operator in its turn switches on the service or product the customer wants and directs the charge of transaction to the identified customer.

2. A method according to claim 1 characterized in that after the number of the service operator the customer taps his/her individual PIN code before the service operator accepts the correctness of the phone alarm.

3. A method according to claim 1 characterized in that the service operator asks for the code number series over phone or in the display of the device from which a service or a product is ordered.

4. A method according to claim 1 characterized in that after receiving an accepted order call, the service operator swiches on the service or product giving over telephone an alarm signal, without the call getting switched on, to the respective device producing the service or the product and furnished with a device that receives calls.

5. A method to any of the above claims 1-4 characterized in that the service operator maintains a different order phone number for each product or service-producing device.
